(19) United States
(12) Patent Application Publication
(10) Pub. No.: US 2016/0291783 A1
(43) Pub. Date: Oct. 6, 2016

(54) An Apparatus for User Input and/or User Output

(71) Applicant: NOKIA TECHNOLOGIES OY, Espoo (FI)

(72) Inventors: Darryl COTTON, St. Ives (GB); Chris BOWER, Ely (GB); Piers ANDREW, Cambridge (GB)

(21) Appl. No.: 15/035,520

(22) PCT Filed: Oct. 30, 2014
(86) PCT No.: PCT/FI2014/050812

§ 371 Date: May 10, 2016

(30) Foreign Application Priority Data
Nov. 26, 2013 (GB) 1320791.5

(51) Int. Cl. G06F 3/041; B32B 3/26; B32B 7/12; G06F 3/044

(52) U.S. Cl. CPC G06F 3/0416; G06F 3/0412; G06F 3/044; B32B 3/266; B32B 7/12; G06F 2203/04102; G06F 2203/04103; B32B 2457/20

(57) ABSTRACT

An apparatus including a flexible laminate structure including a first layer and a second layer and including perforations that extend through the first layer but not through the second layer, wherein the first layer is a functional layer used to enable user input to or output from the apparatus.

### TECHNOLOGICAL FIELD

Embodiments of the present invention relate to an apparatus for user input and/or user output. At least some embodiments relate to a flexible apparatus for user input and/or user output.

### BACKGROUND

Electronic apparatus often have circuitry that enables a user to input controls to the electronic apparatus and/or comprise circuitry that enables the apparatus to provide an output that can be sensed by the user of the electronic apparatus.

It would be desirable to provide an apparatus for user input and/or user output that is also flexible.

### BRIEF SUMMARY

According to various, but not necessarily all, embodiments of the invention there is provided an apparatus comprising: a flexible laminate structure comprising a first layer and a second layer and comprising perforations that extend through the first layer but not through the second layer, wherein the first layer is a functional layer used to enable user input to or output from the apparatus.

According to various, but not necessarily all, embodiments of the invention there is provided a method of manufacture comprising: forming a flexible laminate structure comprising a first layer and a second layer and comprising perforations that extend through the first layer but not through the second layer, wherein the first layer is a functional layer used to enable user input to or output from the apparatus.

### BRIEF DESCRIPTION

For a better understanding of various examples that are useful for understanding the brief description, reference will now be made by way of example only to the accompanying drawings in which:

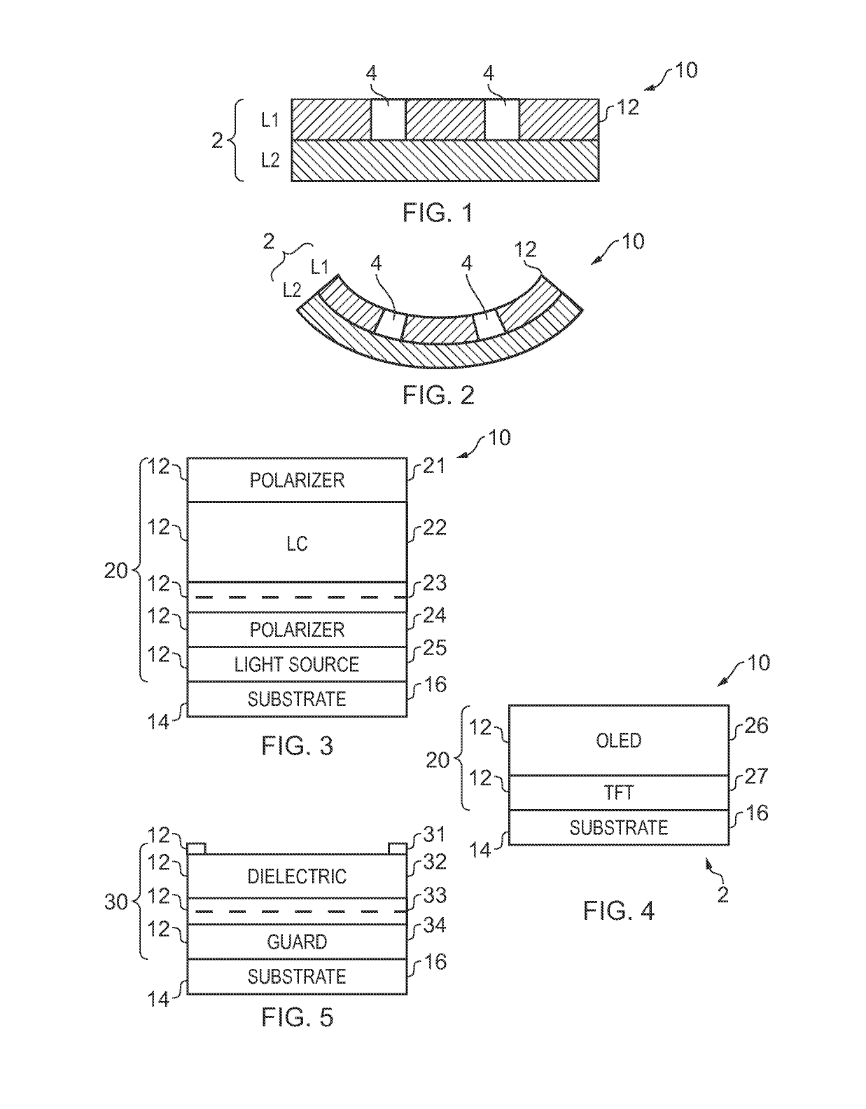

FIG. 1 illustrates an example of a flexible apparatus for user input and/or user output;

FIG. 2 is an example of a flexible apparatus as illustrated in FIG. 1, when it is flexed;

FIG. 3 illustrates an example of a flexible apparatus for at least user output;

FIG. 4 illustrates an example of a flexible apparatus for at least user output;

FIG. 5 illustrates an example of a flexible apparatus for at least user input;

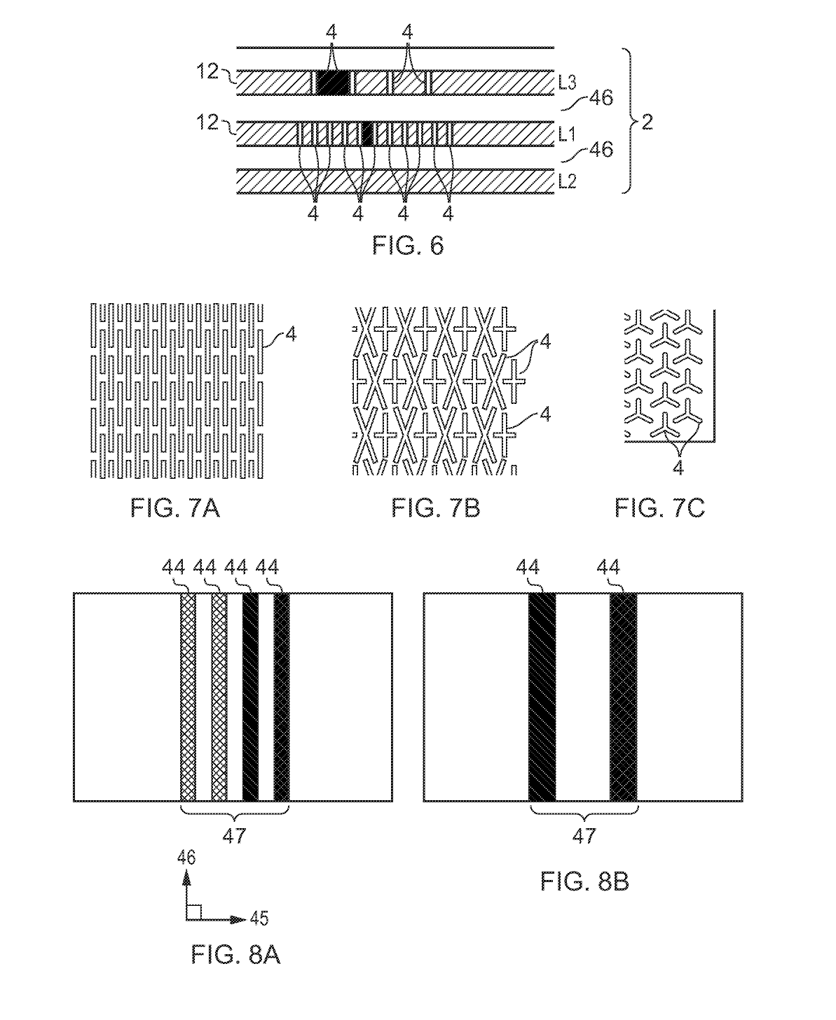

FIG. 6 illustrates another example of a flexible apparatus as illustrated in FIGS. 1 and 2;

FIGS. 7A, 7B and 7C illustrate patterns of perforations;

FIGS. 8A and 8B illustrate alternative patterns of perforations;

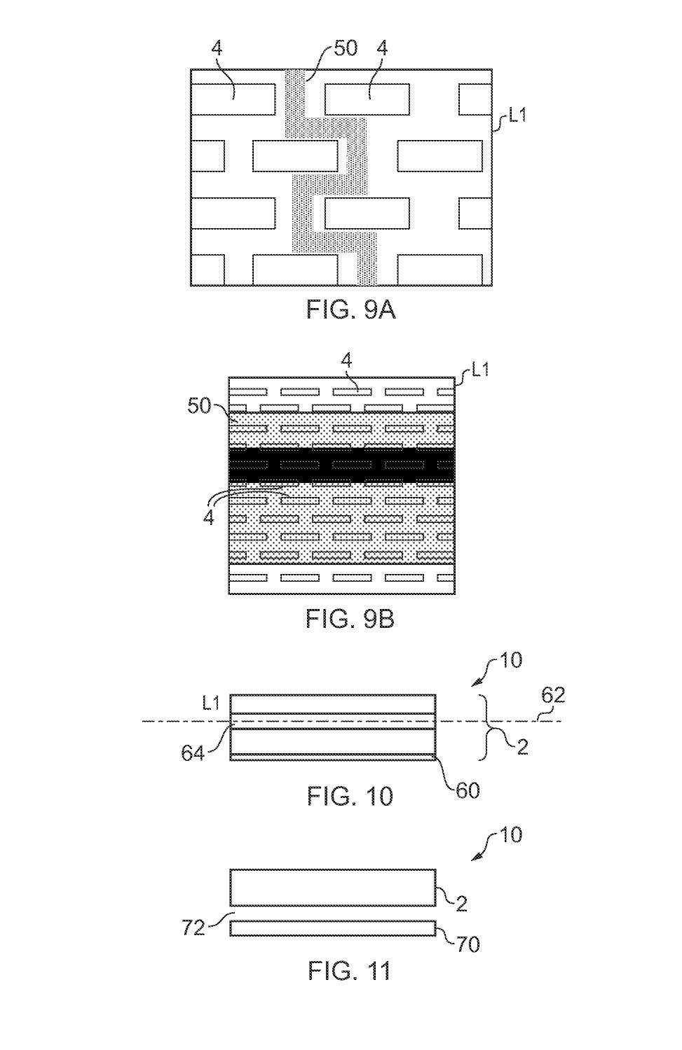

FIGS. 9A and 9B illustrate combinations of perforations and conductive tracks;

FIG. 10 illustrates an example of a flexible apparatus in which a flexible laminate structure comprises a structural support layer;

FIG. 11 illustrates an example of a flexible apparatus 10 comprising a flexible laminate structure and an additional separate layer.

### DETAILED DESCRIPTION

The figures illustrate an apparatus 10 comprising: a flexible laminate structure 2 comprising a first layer L1 and a second layer L2 and comprising perforations 4 that extend through the first layer L1 but not through the second layer L2, wherein the first layer L1 is a functional layer 12 used to enable user input to or output from the apparatus 10.

FIG. 1 illustrates an example of such an apparatus 10 for user input and/or user output. The apparatus 10 is flexible.

The apparatus comprises a flexible laminate structure 2 comprising a plurality of stacked layers. The flexible laminate structure 2 has a depth, a width and a length. The layers are stacked depthwise. Each layer extends lengthwise and widthwise. Each layer may be parallel to its adjacent layer(s).

The flexible laminate structure 2 comprises at least two layers, a first layer L1 and a second layer L2.

The first layer L1 has perforations 4 but the second layer L2 does not have perforations. The perforations 4 in the first layer L1 extend all of the way through the first layer L1.

The first layer has an active function in relation to user input and/or user output. That is, the first layer L1 is a functional layer 12 that is used to enable user input to or output from the apparatus 10.

FIG. 2 is an example of the apparatus 10 illustrated in FIG. 1, when it is flexed. In this example the flexing of the apparatus 10 is a bend that creates a lengthwise curve in the apparatus 10. The perforations 4 in the first layer L1 enable the effective modulus of the first layer L1 to be controlled. This allows the location of a neutral axis (zero strain) in the apparatus 10 to be controlled. The location of the neutral axis may determine strain at a given location. The perforations 4 in the layer L1 can therefore reduce the likelihood of de-lamination of the laminate structure 2.

FIG. 3 illustrates an example of an apparatus 10 as previously illustrated in FIGS. 1 and 2. In this example, the apparatus 10 is configured as a user output apparatus 10.

The apparatus 10 comprises a flexible laminate structure 2 comprising user output functional layers 20 and a non-functional layer 14. The user output functional layer is configured to enable control of output to a user.

In this example, the user output apparatus 10 is a display apparatus and the user output functional layers 20 are display functional layers. A display functional layer 20 is configured to enable control of light output to a user. It may, for example, be a light modulation layer 22. In this example, the non-functional layer 14 may be a structural support layer 16 such as a substrate.

In this example, the display functional layers 20 include a lighting layer 25 such as a lightguide or reflector, a polarizer layer 24, an electrode layer 23, an overlying light modulation layer 22 and a polarizer layer 21.

Any one or more of the display functional layers 20 may operate as the first layer L1 described in relation to FIGS. 1 and 2. In this example, the functional layer 12 described in relation to FIGS. 1 and 2 may be the polarizer 21, the light modulation layer 22, the electrode layer 23, the polarizer 24 or the lighting layer 25. The non-functional layer 14 operates as the second layer L2 described in relation to FIGS. 1 and 2.

In some examples the light modulation layer 22 may be a liquid crystal layer. In other examples, the light modulation layer 22 may be an electrophoretic layer, an electrochromic layer or a polymer dispersed liquid crystal layer.

FIG. 4 illustrates an example of an apparatus 10 as previously illustrated in FIGS. 1 and 2. In this example, the apparatus 10 is configured as a user output apparatus 10.

The apparatus 10 comprises a flexible laminate structure 2 comprising user output function layers 20 and a non-functional layer 14. The user output function layer is configured to enable control of output to a user.

In this example, the user output apparatus 10 is a display apparatus and the user output functional layers 20 are display function layers. A display function layer 20 is configured to enable control of light output to a user. The display function layers 20 include a thin film transistor layer 27 comprising a plurality of different transistors and an organic light emitting diode layer 26. In this example, the non-functional layer 14 may be a structural support layer 16 such as a substrate.

In other examples, the display function layers 20 may include color filter layers.

Any one or more of the display functional layers 20 may operate as the first layer L1 described in relation to FIGS. 1 and 2. In this example, the functional layer 12 described in relation to FIGS. 1 and 2 may be the thin film transistor layer 27 and/or the organic light emitting layer 26. The non-functional layer 14 operates as the second layer L2 described in relation to FIGS. 1 and 2.

FIG. 5 illustrates an example of an apparatus 10 as previously illustrated in FIGS. 1 and 2. In this example, the apparatus 10 is configured as a user input apparatus 10.

The apparatus 10 comprises a flexible laminate structure 2 comprising user input functional layers 30 and a non-functional layer 14. The user input functional layer 30 is configured to enable sensing a parameter for detection of user input.

In this example, the user input apparatus 10 is a touch sensitive apparatus 10 and the user input functional layers 30 are touch input functional layers. A touch input functional layer 30 is configured to enable sensing a parameter, such as optical intensity or capacitance, for detection of user touch input. The touch input functional layers 30 include, in this example, an electrode layer 33 comprising a plurality of capacitor sensor electrodes, a dielectric layer 32 overlying the electrode layer 33. In some embodiments the touch input functional layers 30 may also comprise a continuous lower guard layer 34 and/or a guard layer 31 at the edges. In this example, the non-functional layer 14 may be a structural support layer 16 such as a substrate.

Any one or more of the touch input functional layers 30 may operate as the first layer L1 described in relation to FIGS. 1 and 2. In this example, the functional layer 12 described in relation to FIGS. 1 and 2 may be the electrode layer 33, the dielectric layer 32, the top guard layer 31 or the bottom guard layer 34. The non-functional layer 14 operates as the second layer L2 described in relation to FIGS. 1 and 2.

It will be appreciated from the descriptions of FIGS. 3, 4 and 5 that the functional layer 12, that is layer L1, may be an electrically controllable layer. Examples of this include the light modulation layer 22, the electrode layer 23, the thin film transistor layer 27, the organic light emitting diode layer 26, the electrode layer 33, the lower guard later 34 or the upper guard layer 31.

It will also be appreciated from the descriptions of FIGS. 3, 4 and 5 that the functional layer 12 may be a passive functional layer. Examples of a passive functional layer 12 include the polarizer layer 21, the polarizer layer 24, the lighting layer 25, the dielectric layer 32, color filter layers, and, in some implementations, where a voltage is not applied to a guard layer 31, 34 that guard layer.

Referring back to the examples of FIGS. 1 and 2, with reference to FIGS. 3 to 5, the second layer L2, which does not have perforations 4, may also be a functional layer 12 as described above. For example, it may be a display layer that defines a plurality of pixels such as, the electrode layer 23 in FIG. 3 or the thin film transistor layer 27 in FIG. 4.

Alternatively, the second layer L2 may be a non-functional layer 14 such as a structural support layer 16 or a protective layer such as a protective window.

FIG. 6 illustrates another example of the apparatus 10, similar to that illustrated in FIGS. 1 and 2 and as referred to in FIGS. 3, 4 and 5.

In this example, the flexible laminate structure 2 comprises a first layer L1, a second layer L2 and a third layer L3. The perforations 4 extend through the first layer L1 but not through the second layer L2. The perforations 4 also extend through the third layer L3 but not through the second layer L2.

In this example the first layer L1, which comprises perforations 4, is a functional layer 12. The third layer L3 may be a functional layer 12 as illustrated in FIG. 6, or in alternative embodiments may be a non-functional layer 14.

In some embodiments, some or all of the perforations 4 in the third layer L3 coincide with some or all of the perforations 4 in the first layer L1. However, in the example illustrated in FIG. 6, some or all of the perforations 4 in the third layer L3 do not coincide with the perforations 4 in the first layer L1. In the example of FIG. 6, none of the perforations in the first layer L1 overlap the perforations 4 in the second layer L2.

In the example of FIG. 6, the density of perforations 4 in the first layer L1 is greater than the density of perforations 4 in the third layer L3. This may, for example, be because the third layer L3 bends more than the first layer L1 when the apparatus 10 is flexed. The layer which has the most strain is dependent upon the where the neutral axis of the laminate structure is. If it is in L2 then L3 will have to lengthen or shorten more than L1 during flexing. The number of perforations can also be used to determine where the neutral axis is.

The configuration where L1 has more perforations than L3, may allow the shear to be continuous across layers 46 and L1 and hence be reduced. This may also allow multiple neutral axis to be formed through decoupling L3 and L2.

FIGS. 7A, 7B and 7C illustrate examples of different patterns of perforations 4 which may be used in the laminate structure 2.

The perforations 4 in the first layer L1 may be configured in a first pattern and the perforations 4 in the third layer L3 may be configured in a second pattern different to the first pattern.

As illustrated in FIGS. 8A and 8B, the perforations 4 may be unevenly distributed along the longitudinal direction 45 of the first layer L1 (or third layer L3). In figures 8A and 8B, the perforations 4 are constrained to only the stripe areas 44. In FIGS. 8A and 8B a series of distinct separated stripe areas 44 are distributed over a region 47 where the apparatus 10 would be folded. These stripe areas 44 are separated in the longitudinal direction 45 and comprise perforation 4 evenly distributed in the lateral direction 46 across the whole width of the layer.

In FIG. 8A, the stripe areas 44 are evenly distributed through the region 47 whereas in FIG. 8B, the stripe areas are not evenly distributed through the region 47. In FIG. 8B, the stripe areas 44 are positioned at the end of the region 47 where the apparatus 10 would be flexed.

In the examples of FIGS. 8A and 8B, the perforations 4 are positioned only in the region 47 where flexing occurs. In other embodiments, different perforation patterns may be provided in areas where different functions are provided. For example, in an area where a display output is provided, it may be desirable to have no perforations 4 or perforations 4 that are small in size so that they do not interfere with the display output. However, in regions where there is no display output, it may be possible to use larger perforations 4 without affecting the display output.

Referring to FIGS. 7A, 7B and 7C the perforations 4 illustrated may be micro-perforations or nano-perforations.

In some examples, the largest dimension of the perforations 4 may determined by the visual acuity of the human eye. For example, the largest dimension of the perforations 4 may be less than 100 micrometers so that the perforations are not easily resolved by the human eye in normal use.

In some examples, the periodicity of the perforations 4 is controlled to reduce or prevent

diffraction effects caused by constructive and/or destructive interference of scattered light. It may be desirable for the perforations to have a periodicity less than 200 nm. The perforations 4 will then be less than 100 nm in width.

Referring back to FIG. 6, the perforations 4 in the first layer L1 and the perforations 4 in the third layer L3 are adjacent to adhesive layers 46. The adhesive layers 46 may have a low Young's modulus. For example, the Young's modulus of the adhesive layer 46 may be less than the Young's modulus of the first layer L1 and it may also be less than the Young's modulus of the third layer L3.

The adhesive layer 46 may be deposited as a liquid. It may be advantageous if the adhesive layer 46 fully or partially fills the perforations 4.

The adhesive layer 46 may be clear.

In some embodiments, the adhesive layer 46 may be optically matched to its adjacent layer. For example, an adhesive layer 46 may have the same refractive index as an adjacent first layer L1 and an adhesive layer 46 may have the same refractive index as an adjacent third layer L3. The matching of refractive indexes will minimize or reduce refractive and/or diffractive effects.

FIG. 9A illustrates an example of a layer, such as the first layer L1, comprising perforations 4. In this example the first layer L1 also comprises conductive tracks 50. In the example of FIG. 9A, the conductive tracks 50 meander around the perforations 4 and do not extend over the perforations 4.

FIG. 9B is an example of a layer, such as the first layer L1, comprising perforations 4. In this example the first layer L1 comprises conductive tracks 50. In this example the conductive tracks 50 extend over the perforations 4. In this example, the conductive tracks 50 are continuous where they extend over the perforations. In other examples, the conductive tracks 50 may have also have perforations, which may or may not be aligned with the perforations 4.

In some embodiments, a single first layer L1 may be configured both as illustrated in FIG. 9A and as illustrated in FIG. 9B. For example, over a display region of the apparatus 10, the perforations 4 may be small and it may be desirable to have conductive tracks 50 that extend over the perforations 4 as illustrated in FIG. 9B.

In areas outside of the display area, it may be desirable to have the conductive tracks 50 meander around the perforations 4 which are larger in this area than over the display area.

FIG. 10 illustrates an example of the apparatus 10 in which the flexible laminate structure 2 comprises a structural support layer 60. The structural support layer 60 is stiff and its purpose is to shift the neutral plane 62 within the laminate structure 2. The neutral plane 62 is the plane within the laminate structure where strain is zero on flexing the apparatus 10. In the illustrated example, the structural support layer 60 shifts the neutral plane 62 so that it coincides with a display layer 64 defining display pixels. In this example, the display layer 64 is not the first layer L1 described with reference to the preceding examples. It may be the second layer L2. As described in the preceding examples, the laminate structure 2 does comprise a first layer L1 comprising perforations 4 as previously described. In the illustrated example, the first layer L1 is illustrated as being positioned on the opposite side of the display layer 64 than the structural support layer 60. However, in other embodiments they may be positioned on the same side.

FIG. 11 illustrates an example of the apparatus 10 comprising the flexible laminate structure 2 and also additionally comprising a separate layer 70 separated from the laminate structure 2 by a fluid gap 72. The fluid gap 72 may for example be an air gap or a liquid such as an uncured optically clear adhesive material or refractive index matching liquid/gel.

The gap 72 mechanically isolates the laminate structure 2 from the additional layer 70.

In some embodiments, the flexible laminate structure 2 may comprise a display layer 64 defining display pixels. However, in other examples the display layer 64 may be positioned in the additional layer 70 rather than in the laminate structure 2.

In some embodiments, the flexible laminate structure 2 may comprise a protective window. However, in other examples the protective window may be positioned in the additional layer 70 rather than in the laminate structure 2.

In some embodiments, the flexible laminate structure 2 may comprise capacitive touch sensors defining the display pixels. However, in other examples the capacitive touch sensors may be positioned in the additional layer 70 rather than in the laminate structure 2.

As used here ‘module’ refers to a unit or apparatus that excludes certain parts/components that would be added by an end manufacturer or a user to an unfinished apparatus to form a finished apparatus. The apparatus 10 may be a module or may be an unfinished flexible electronic apparatus or a finished flexible electronic apparatus.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one . . . ” or by using “consisting”.

In this brief description, reference has been made to various examples. The description of features or functions in relation to an example indicates that those features or functions are present in that example. The use of the term ‘example’ or ‘for example’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’ or ‘may’ refers to a particular instance in a class of examples. A property of the instance can be a property of only that instance or a property of the class or a property of a sub-class of the class that includes some but not all of the instances in the class.

Although embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/We claim:

1. An apparatus comprising:
a flexible laminate structure comprising a first layer and a second layer and comprising perforations that extend through the first layer but not through the second layer, wherein the first layer is a functional layer used to enable user input to or output from the apparatus.

2. An apparatus as claimed in claim 1, wherein the functional layer is a user output functional layer configured to enable control of output to a user.

3. An apparatus as claimed in claim 1, wherein the functional layer is a display functional layer configured to enable control of light output to a user.

4. (canceled)

5. An apparatus as claimed in claim 1, wherein the functional layer is a touch input functional layer configured to enable sensing a parameter for detection of user touch input.

6. An apparatus as claimed in claim 1, wherein the functional layer is an electrically controllable layer.

7. (canceled)

8. An apparatus as claimed in claim 1, wherein the first layer comprises a plurality of capacitive touch sensors and conductive tracks.

9. An apparatus as claimed in claim 1 wherein the second layer is a functional layer.

10. An apparatus as claimed in claim 1, wherein the second layer is a display layer that defines a plurality of display pixels.

11. (canceled)

12. An apparatus as claimed in claim 1, wherein the laminate structure comprises a third layer, and the third layer comprises perforations that extend through the third layer.

13. (canceled)

14. An apparatus as claimed in claim 12, wherein at least some of the perforations in the first layer do not overlap at least some of the perforations in the third layer.

15. (canceled)

16. (canceled)

17. An apparatus as claimed in claim 12, wherein the first layer comprises perforations configured in a first pattern and the third layer comprises perforations configured in a second different pattern.

18. An apparatus as claimed in claim 1, wherein the first layer comprises perforations configured in a first pattern, wherein the first pattern is a variable pattern that varies in a first direction.

19. An apparatus as claimed in claim 18, wherein the first variable pattern of perforations is configured such that there is a greater density of perforations where flexing occurs compared to where flexing does not occur.

20. An apparatus as claimed in claim 18, wherein the variable first pattern of perforations is such that the density of perforations varies with the function of the area at which the perforations occur.

21. (canceled)

22. (canceled)

23. An apparatus as claimed in claim 1, wherein the first layer is bonded to an adjacent layer in the laminate structure using adhesive.

24. (canceled)

25. (canceled)

26. (canceled)

27. An apparatus as claimed in claim 1 further comprising conductive tracks, wherein the conductive tracks meander around the perforations in the first layer.

28. (canceled)

29. (canceled)

30. (canceled)

31. An apparatus as claimed in claim 1 wherein the flexible laminate structure comprises a protective window.

32-36. (canceled)

37. A method of manufacture comprising:
forming a flexible laminate structure comprising a first layer and a second layer and comprising perforations that extend through the first layer but not through the second layer, wherein the first layer is a functional layer used to enable user input to or output from the apparatus.

38. (canceled)

39. (canceled)

40. A method as claimed in claim 37, wherein the adhesive at least partially fills the perforations in the first layer.

41. (canceled)

42. (canceled)

43. A method as claimed in claim 37, comprising forming conductive tracks that meander around the perforations in the first layer.

44. (canceled)
